(19) United States
(12) Patent Application Publication
(10) Pub. No.: US 2008/0128659 A1
(43) Pub. Date: Jun. 5, 2008

(54) Biologically modified buckypaper and compositions

(76) Inventors: Reginald Parker, Tallahassee, FL (US); Ray O'Neal, Tallahassee, FL (US); Jesse Edwards, Tallahassee, FL (US)

Correspondence Address: Jerome J. Norris;Norris, Braden, Melton & Gregersen, PLLC, Suite 305, 1901 Pennsylvania Avenue, N.W., Washington, DC, 20006, US

(21) Appl. No.: 11/633,605

(22) Filed: Dec. 5, 2006

(51) Int. Cl. G21F 1/00

(52) U.S. Cl. 252/478

(57) ABSTRACT

A composite for providing shielding against cosmic radiation, consisting essentially of carbon nanotubes, a biopolymer of lignin and a halogen as dopant.

### BACKGROUND OF THE INVENTION

I. Field of the Invention

The present invention relates to biologically modified buckypaper and high filler loaded lignin-CNT (buckypaper)-resin nanocomposites, and the use of these, respectively, to shield high energy radiation and to increase tensile strength over CNT per se.

II. Description of the Related Art

The entire range of the electromagnetic spectrum or radiant energies or wave frequencies from the longest to the shortest wavelengths are as follows:

Gamma, X-rays, UV, visible, IR, microwaves and RF.

In this connection, it is to be noted that radiation shields are required for human and various non-human cargo outside of the atmosphere, due to the fact that cosmic radiation (alpha, beta and gamma radiation) is deleterious to human health, electronic systems and the mechanical integrity of polymer materials.

Currently, lead is used as an effective radiation shield; however, the use of lead is burdensome because of its weight and expensive due to the amount of lead required for effective shielding.

Accordingly, new materials for shielding radiation are required that are light-weight, inexpensive and easy to manufacture, and these new materials should be useful in medical laboratories against secondary nuclear radiation, as well as cosmic radiation.

More particularly, electromagnetic shielding needs are in high demand and EM shielding materials are needed for sensitive electronic equipment and components, and protection of computer equipment from RF radiation that causes interference to navigation systems, life support systems, etc. Although metals have been utilized to perform EM shielding for a good while, replacement of these metals by a wide variety of polymeric type materials has given rise to a loss of the metals' EM shielding qualities.

Liu et al. disclose “Controlled Deposition of Individual Single-Walled Carbon Nano-Tubes on Chemically Functionalized Templates”, Chemical Physics Letters 303: 125-129, April 1999.

B. Tang et al. disclose “Preparation, Alignment, and Optical Properties of Soluble Poly(Phenylacetylene)-Wrapped Carbon Nanotubes”, Macromolecules, 3 2(8) 2569-2576, March 1999.

C. Journet et al. disclose “Large-Scale Production of Single-Walled Carbon Nano-Tubes by the Electric-Arc Technique”, Nature 388, 756-758, August 1997.

Y. Chen et al. disclose “Chemical Attachment of Organic Functional Groups to Single-Walled Carbon Nanotube Material”, J. Mater. Res, vol. 13, No. 9, pp 2423-2431, September 1998.

There is a need for bountiful and relatively inexpensive EM shielding materials for sensitive electronic equipment and components, aircraft navigation systems, and for protection of computer equipment from RF radiation.

### SUMMARY OF THE INVENTION

One object of the invention is to provide bountiful and relatively inexpensive radiation shields for human and non-human cargo that is effective against cosmic radiation (alpha, beta and gamma rays).

Another object of the present invention is to provide bountiful and relatively inexpensive radiation shields for human and non-human cargo that is light-weight and easy to manufacture and use.

A further object of the present invention is to provide bountiful and relatively inexpensive high strength composite materials by incorporating lignin into a CNT dispersion followed by filtration to form a sheet with increased tensile strength of the composite by over 150%.

These and other objects of the invention will become more apparent by reference to the Brief Description Of the Drawings and Detailed Description of the Preferred Embodiments of the Invention.

### BRIEF DESCRIPTION OF THE DRAWINGS

FIG. 1 is a schematic of the process for preparing dried buckywood composite layer.

FIG. 2 is a graph showing MeV-cm2/g versus alpha particle energy to compare alpha radiation stopping power for the biopolymer composition of the invention versus that of polyethylene.

FIG. 3 is a graph showing MeV-cm2/g versus electron energy to compare beta radiation stopping power for the biopolymer composition of the invention compared to polyethylene.

FIG. 4 is a graph showing MeV-cm2/g versus proton energy to compare gamma stopping radiation power for the biopolymer composition of the invention compared to polyethylene.

FIG. 5 is a graph showing the percent blocking observed for alpha, beta and gamma radiation for the biopolymer composition of the invention.

FIG. 6 is graph depicting the mechanical strength of CNT with lignin biopolymer compared to CNT alone.

FIG. 7 shows an atomic force/scanning probe microscopy picture of the mixture of lignin with CNT.

### DESCRIPTION OF PREFERRED EMBODIMENT OF THE INVENTION

Buckywood composites were formed from preformed single-walled carbon nanotubes (SWNTs), which are thin sheets (films) with well-controlled dispersion and porous networks of SWNTs—by multi-stepped dispersion and filtration processes of nanotube suspension. The nanotube buckypapers (NBPs) were then wetted with Epon 862 epoxy resin to make the nanocomposite material as shown by the schematic of the process in FIG.

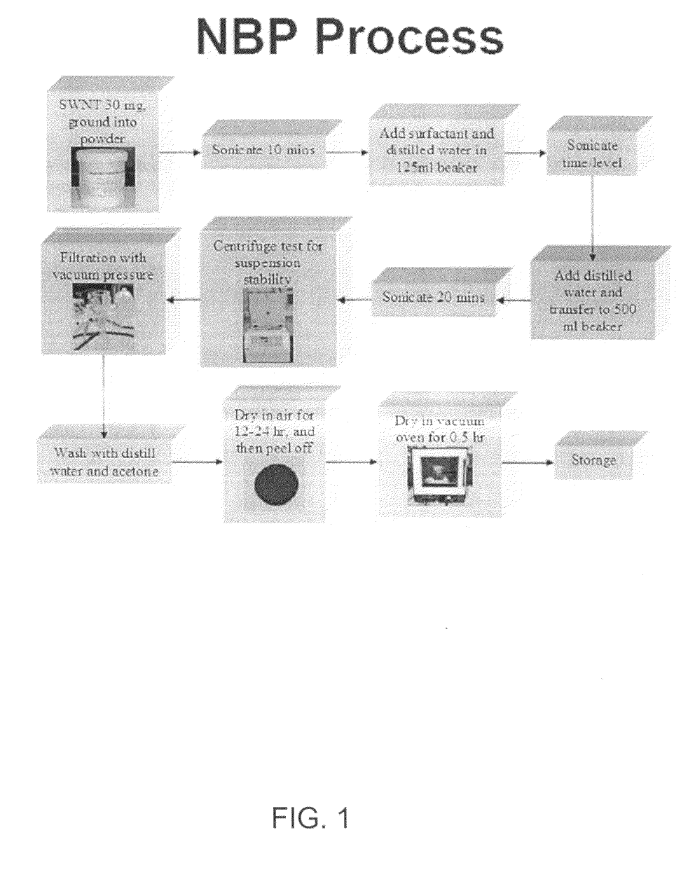

In the process of FIG. 1 sonication applies sound (ultrasound) energy through “a sonicator”—a bath of water through which sound is transmitted to help agitate particles within a vessel being sonicated. This speeds dissolution of the particles and is especially helpful when physically stirring is not possible. It also provides the energy for chemical reactions to proceed. The three sonication steps of the process help create the e-fields between materials with highly differentiated chemical potentials that are made close enough through dispersion.

The components of the suspension contain about 14% carbon nanotubes, about 57% of a biopolymer of lignin, and about 29% of iodine by weight as a dopant. Other components or property modifiers may be thickeners, or charged semiconductor particles—so long as these other components do not dilute the composition to less than 90% by weight. Also, any of the halogens will suffice as the dopant because of their similar chemistry.

Buckywood composites is a filtrand as a result of filtration of this suspension.

In general, the radiation shielding capability or power of an element is determined by the Bethe-Bloche equation, and the equation determines the radiation stopping power in accordance with the following formula:

$$- \frac{d E}{d x} = {Kz}^{2} \frac{Z}{A} \frac{1}{{β}^{2}} [ \frac{1}{2} ln \frac{2 {m}_{e} {c}^{2} {β}^{2} {γ}^{2} {T}_{max}}{{I}^{2}} - {β}^{2} - \frac{δ}{2} ]$$

However, to determine the radiation stopping power of a compound by way of Stoichiometric calculations, it is necessary to use the Bragg Additivity equation, which is as follows:

$${\frac{d E}{d x} = \sum {w}_{j} \frac{d E}{d x} \vert}_{j}$$

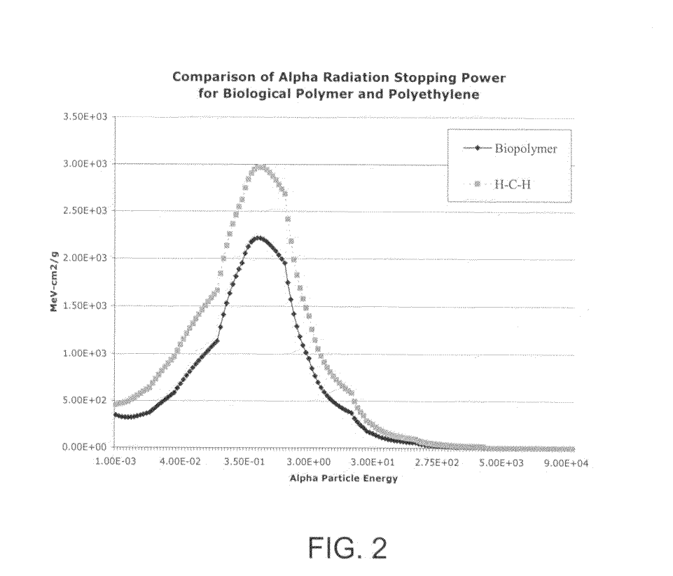

A comparison of the alpha radiation stopping power of the lignin biopolymer composition of the invention with polyethylene may be seen from FIG. 2 which measures the MeV-cm2/g versus alpha particle energy. It is clear from this graph that the cheaper lignin biopolymer composition emulates the alpha radiation stopping power of polyethylene, which is a far more expensive synthetic product.

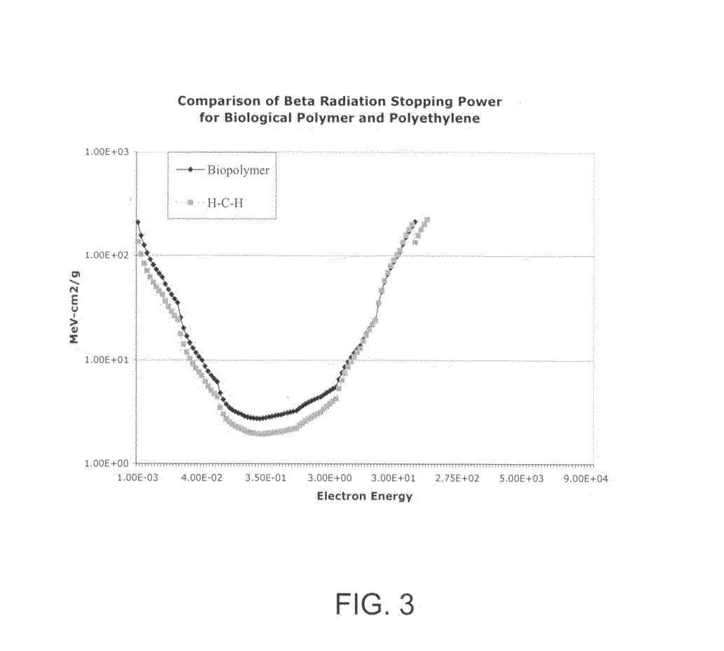

The graph of FIG. 3 compares the beta radiation stopping power of the lignin biopolymer composition of the invention versus polyethylene. The graph measures the MeV-cm2/g versus electron energy. It is clear that the graph of the less expensive lignin biopolymer composition of the invention mirrors that of the beta radiation stopping power of the more expensive polyethylene.

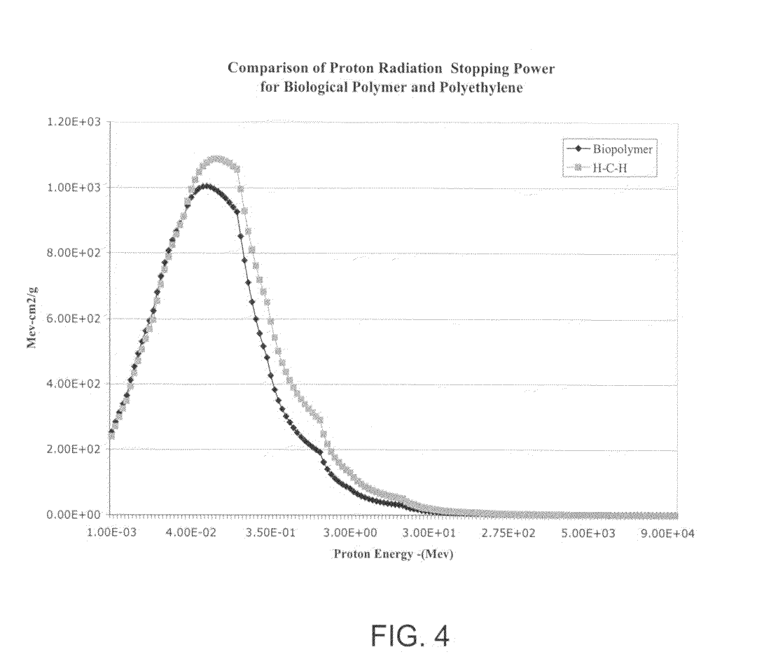

The graph of FIG. 4 compares the gamma radiation stopping power of the lignin biopolymer composition of the invention to that of polyethylene by measuring MeV-cm2/g versus proton energy. The pattern of this graph clearly evidences the effectiveness of the cheaper lignin biopolymer composition of the invention to that of the more expensive polyethylene.

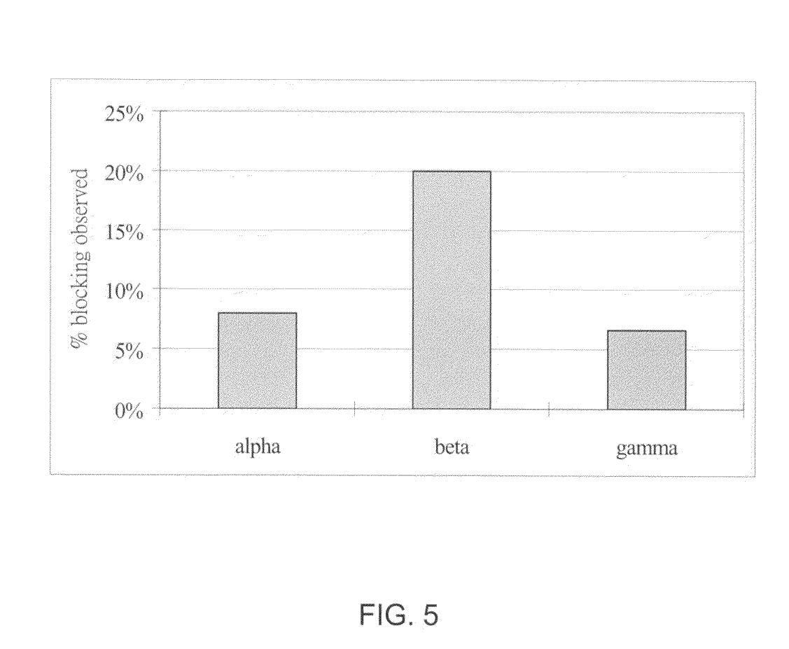

The biologically modified buckypaper composition of the invention is clearly shown to have significant radiation blocking power for alpha, beta and proton radiation via the theoretical calculations (Bethe-Bloche and Bragg Additivity) and this is borne out by the graph of FIG. 5 which shows the percent blocking observed for alpha, beta and gamma radiation using the biologically modified buckypaper composition of the invention. The Geiger counter measurement procedure averaged 10 runs and repeated each run 10 times and the calculated average shielding is: blocking %=(no shield−shield)/no shield.

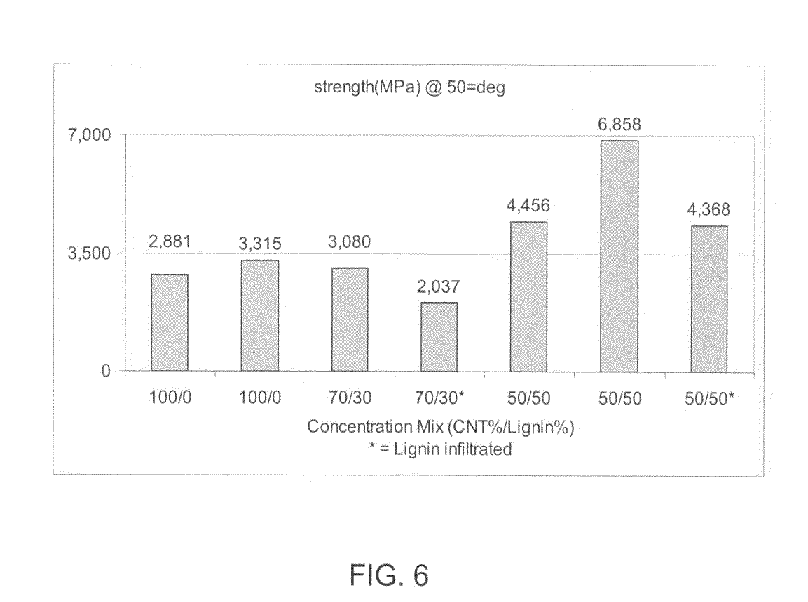

Another aspect of the invention is to incorporate lignin into a CNT dispersion followed by filtration to form a sheet for composite formation. It has been found that when using a concentration mix of CNT alone compared to a concentration mix of CNT with 50% lignin by weight, as shown in FIG. 6, the tensile strength (MPa) or mechanical strength of the composite is increased by over 150%.

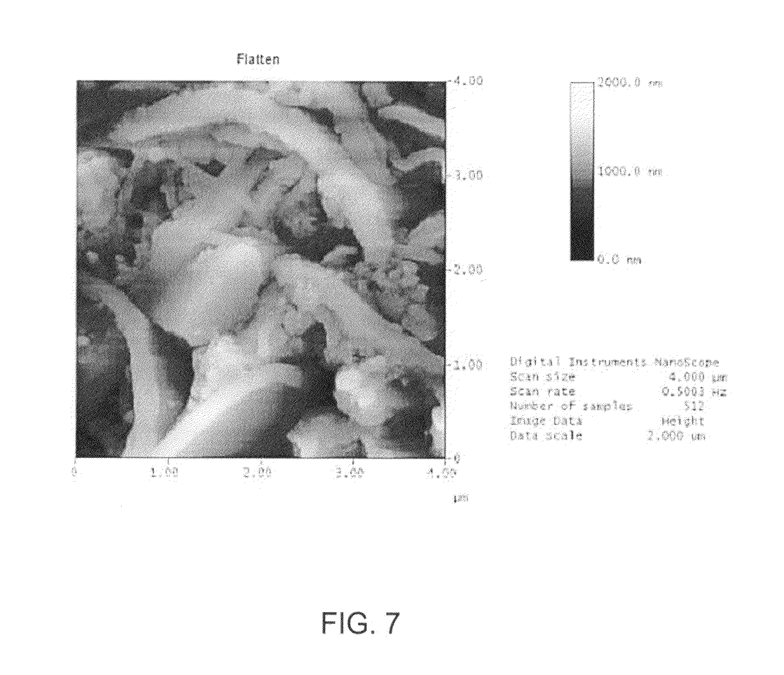

Atomic Force/Scanning Probe Microscopy is used to obtain a picture of the atomic force microscopes of lignin mixed with CNT, and this picture is shown in FIG. 7.

This instrument is an extremely high resolution profilometer. A silicon nitride or silicon tip is scanned across the surface of a sample at a constant force, the position of the tip on the sample surface is controlled by three piezoelectric ceramics. These piezoelectrics are controlled by a microcomputer which monitors the position of the tip via the signal form a photodiode which receives reflected laser light from the top of the tip support. Two dimensional scans allow the construction of images of the sample surface, rather than just line profiles. The instrument is capable of imaging areas as large as 125 μm̂2 and as small as a few tens of nanometers square. The maximum spatial resolution is such that the atomic surface of the structure may be revealed.

The picture of FIG. 7 shows that the lignin biopolymer is highly interactive with the buckywood.

We claim:

1. A composite for providing shielding against cosmic radiation, consisting essentially of:
carbon nanotubes, a biopolymer of lignin and a halogen as dopant.

2. The composite of claim 1 wherein said cosmic radiation is alpha radiation.

3. The composite of claim 1 wherein said cosmic radiation is beta radiation.

4. The composite of claim 1 wherein said cosmic radiation is gamma radiation.

5. The composite of claim 1 wherein the halogen is iodine.

6. The composite of claim 1 wherein said carbon nanotubes is present in a amount of about 14% by weight, said biopolymer of lignin is present in an amount of about 57% by weight, and said halogen is present in an amount of about 29% by weight.

7. The composite of claim 6 wherein said halogen is iodine.

8. A method of making a cosmic radiation shielding comprising:
providing a composite comprising a mixture of carbon nanotubes, a biopolymer of lignin and a halogen dopant.

9. The method of claim 8 wherein said cosmic radiation is alpha radiation.

10. The method of claim 8 wherein said cosmic radiation is beta radiation.

11. The method of claim 8 wherein said cosmic radiation is gamma radiation.

12. The method of claim 8 wherein said carbon nanotubes is present in an amount of about 14% by weight, said biopolymer of lignin is present in an amount of about 57% by weight, and said halogen is present in an amount of about 29% by weight.

13. The method of claim 12 wherein said halogen is iodine.
